(19) United States
(12) Patent Application Publication
(10) Pub. No.: US 2025/0086146 A1
(43) Pub. Date: Mar. 13, 2025

(54) CUSTOMIZED OBJECTS DEFINED BY MULTIPLE SCHEMA FRAGMENTS

(71) Applicant: DevRev, Inc., Palo Alto, CA (US)

(72) Inventors: Jan Olderdissen, Herrenberg (DE); Shivansh Rai, Bengaluru (IN)

(73) Assignee: DevRev, Inc., Palo Alto, CA (US)

(21) Appl. No.: 18/465,140

(22) Filed: Sep. 11, 2023

(51) Int. Cl. G06F 16/21

(52) U.S. Cl. CPC G06F 16/211

(57) ABSTRACT

Disclosed is a computer implemented method to define schema fragments (also known as fragment(s)) that comprise multiple custom data fields wherein each fragment can be used to add custom data fields to multiple objects. In accordance with the present specification, a single object is defined by multiple custom data fields from multiple schema fragments. Each schema fragment is defined by a set of custom fields representing similar kind of data fields (like tenant data field, custom data filed, application data fields). Each schema fragment can define multiple objects from multiple schemas.

### FIELD OF THE INVENTION

The subject matter of the present invention relates generally to the field of customizable objects in a ticketing framework. Particularly and not exclusively, the subject matter of the present invention is related to an effective and reliable method for defining a custom or customized object through the combination of multiple schema fragments with defined custom data fields.

### BACKGROUND OF THE INVENTION

The significant problem of conventional development and customer relations management (CRM) systems, which is that developers (“dev”) are greatly isolated from their users/customers (“rev”). By deleting barriers between the “Dev” side and the “Rev” side, this permits embodiments of the invention to easily connect code on the Dev side to production issues and user/customer interactions on the Rev side. This permits software development to do not have to work across silos of different systems to meaningfully communicate and collaborate with their software users and customers.

The system 100 provides a unified platform 110 to implement an automated template for autonomous clustering of events into event hierarchies as well as autonomous classification and communication between these hierarchies. The term “event hierarchy” may also be referred to herein as a “funnel”, since the operation of the system involves the funneling of large amounts of event data from the different hierarchies for processing by the unified platform. Any number or type of event hierarchies may be acted upon by embodiments of the invention. For example, the FIG. 1 illustrates event hierarchies pertaining to developer entities/systems 112, user entities/systems 116, CRM/Revenue-based entities/systems 124, and admin/operator entities/systems 120. The developer entities/systems 112 may correspond to developer data 114, the user entities/systems 116 may correspond to user data 118, the CRM/Revenue-based entities/systems 124 may correspond to CRM/Rev data 126, and the admin/operator entities/systems 120 may correspond to Ops (“operations”) data 122.

In some embodiments, the unified platform 110 uses machine-learning based techniques to automatically process the data and events from the multiple event hierarchies, and to generate one or more databases 106 comprising both raw data and properly categorized data so that analysis tools 104 can be used to extract useful information and accurate results. In this way, a correlated view of the data can be obtained, despite the fact that the event data may originate from numerous disparate and separated systems, and despite the fact that the collected event data may correspond to an immense amount of information that is collected. The system 100 may include one or more user stations 102 to operate the unified platform 110. The user stations and/or the servers that host or operate with the system comprises any type of computing device that may be used to implement, operate, or interface with the system.

The raw data from the various Dev and Rev sources are likely to correspond to an extremely large volume of data, which individually by themselves may not provide enough cross-hierarchy context to be meaningful. That large volume of raw data, when analysed in a unified way across the different hierarchies, may be used to form increasingly smaller and more meaningful sets of data that can be usefully provided to developers, users, managers, and/or any other party that can benefit from a unified cross-hierarchy look at events and data within the system.

FIG. 2 shows example identity relationships between the different clouds according to one embodiment of the invention. This diagram shows a Dev cloud 202, Rev cloud 204, and a TechCompany cloud 206, where TechCompany is the organization that provides the above-described unified platform. Some embodiments pertain to an object model to implement the invention. In the object model, various TechCompany terms may be employed. The term “dev org” refers to the TechCompany's direct customer (account). In the case of TechCompany itself, this will be its own dev org and it's customer's (rev-org) would each be their own dev org. The Dev cloud 202 may include users, environments (development environment, test environment), and products/services. Various terms in the object model may pertain to work management. An “environment” pertains the he notion of a run time, and may correspond to the client's environment (e.g. browser). This can be the runtime for the dev-orgs service/software/build. The term “development environment” refers to a repository such as a source code repository. Examples include GitHub, GitLab, Git, etc. The term “test environment” refers to an environment where code is deployed, and tests are run.

One or more connectors and rovers may be included in the Dev cloud 202 to gather event information to be analyzed in the TechCompany cloud 906. The Rev cloud 204 may include users and environments. One or more connectors and rovers may also be included in the Rev cloud 204 to gather event information to be analyzed in the TechCompany cloud 906. The term “rover” refers to a log/event collector which provides logs/events to the TechCompany platform. These can be collecting both machine or user generated items, and can sit in the Dev “cloud”, Rev “cloud”, TechCompany “cloud” or external. A “connector” is used to synchronize entities between systems. Connectors may synchronize objects bi-directionally in addition to creating objects in the source system. The TechCompany cloud 206 may correspond to components for events and the products/services. The “event” is a granular item generated by a system, user, application, rover, etc. These are things that are commonly not of interest by themselves, however certain types of events may be of interest (e.g. test failure, etc.). Example events include: (a) alert; (b) stack trace; (c) test fail/pass; (d) system generated event (e.g. user crud, ticket creation, etc.). Mechanisms/components are included to perform identification, implement data and systems, and ML model

FIG. 3 illustrates the concept of TechCompany's direct customer (Devs) and their customers (Revs) and the fact that many devs may correspond to a single entity. In this figure the parent account is the legal entity which multiple customers (Devs) may belong or be linked to. It is not uncommon that individual business units may consume the system directly and be direct customers (Devs). The notion of a parent account can be leveraged for consolidated billing, provisioning, user management, etc. Each Dev has their internal users (Dev users) and respective customers (Revs) which in turn have their associated users (Rev users). A Rev may be a customer of multiple Devs under the same parent account.

FIG. 4 illustrates the notion of identity and how a person's identity can be composed of multiple user ids or traits. Core to the system is the concept of identity and linked system user ids (dev or rev uid), external accounts, identifiers (e.g. CRM id, etc.) and event identifiers (e.g. cookie id, device id). These can be linked together with a contact identity using identifying characteristics (email, cell phone, etc.) or upon request by the individual. Given the ability to consolidate common attributes of a user the platform may enable the ability to gather characteristics of the user across multiple organizations and/or sources which may be used to guide targeting and/or provide insights back to the Devs using details of users derived from the platform as a whole. This also gives control back to the user where they can “own” their profile which is decoupled from their user account within the Dev or Rev org.

FIG. 5 shows an illustration of logical relationships that may exist between the user and orgs for Dev 304 and Rev 302. TechCompany's customers (Revs) will have their “dev oid” set to their rev oid. This will ensure that individuals will not get confused as their id (whether as TechCompany's Rev, or as it's own Dev) is the same. The term “dev oid” refers to the unique ID assigned to the dev-org. In some embodiments, the TechCompany is assigned to a dev oid=0. The term “dev user” refers to the TechCompany's direct users. These are part of the Dev-org. The term “dev uid” refers to the unique ID assigned to the dev org's user. The term “dev cloud” refers to where the Dev's Products/Services sit. The term “rev org” refers to the TechCompany's customer's customer (account), which will be on boarded onto TechCompany by the dev org. The term “rev oid” refers to the unique ID assigned to the rev org. The term “rev user” refers to the TechCompany's customer's users, and are part of the Rev org. The term “rev uid” refers to the unique ID assigned to the rev org's user. The term “rev cloud” is where the Dev's Customers sit.

As illustrated in FIG. 6, base classes correspond to the main classes that all TechCompany objects will be based upon. All classes spawn from a generic base class (called atom 402) and each class can be instantiated as an object. The work class 404 is the base class or template for all work item related objects. The term “work” refers to any artifact in the system that requires any work/activities to be performed. Example work items include: a ticket, issue or task. Each one of these may have their own type specific fields and workflows. The term “ticket” pertains to something requiring front-office work. This may be triaged to see if additional work/investigation is required. A ticket can be escalated/linked to an issue. Characteristics of the ticket may include some or all of: (a) Duration of minutes/hours; (b) Can be minor configuration/test changes; (c) Can be a minor activity (e.g. reset password); (d) Lower impact/lower risk potential. Examples may include a customer support ticket or an auto generated ticket from ML. The term “issue” pertains to something requiring back-office work (people writing code, etc.), and may relate to a new feature, a bug fix, etc. Some example characteristics may include, for instance, duration of days/weeks/months, involve writing code (if development product), and/or has a higher impact/risk potential. Examples may include a new feature for a capability or a bug fix for a feature. The term “task” is a granular item of work performed by an associated owner, and may be a task which is part of a ticket or issue. Examples may include peer review, Unit tests, etc.

A part 406 is the base class for all part hierarchy related entities used to define a product or service hierarchy. Example for parts include: Product, service, capability, feature, microservice, component, etc. A product is the highest level of hierarchy in the product stack and the parent of related capabilities and features (a hub or peak). Products typically have the following characteristics: (a) Units of revenue (have P&L); (b) Basis for contracts; (c) Level at which customers are onboarded. A “capability” refers to a subunit of a product and is most commonly associated with the services a product provides. Capabilities typically have the following characteristics: (a) Services; (b) Unit of API scope (e.g. capability 1 vs. capability 2); (c) Unit of licensing/pricing. An example is a TechCompany's work management service (ticketing, issues, etc.). A “feature” is a subunit of a capability and is typically something that the users can control via a flag or something they can experience indirectly. Features typically have the following characteristics: (a) Can be controlled via flags (e.g. on/off); (b) May or may not be visible to end user. Examples may include a TechCompany's work management services or automatic ticket creation, automated issue prioritization, etc. At a physical level, a “microservice” can correspond to a generalized service or more granular “micro” service. These typically directly map to a Product's capability or feature which can be composed of one of more services. Services are a unit of functionality that is meant to be deployed independently and reused by multiple systems. Services typically have the following characteristics: (a) expose an API; (b) may be directly interacted with via an API/UI by the end customer; (c) may be published in a service registry/load balancer (Envoy, etc.). A “component” refers to a unit of functionality that is designed to be part of a system or application. A component corresponds to a library that can be used by multiple microservices. Components typically have the characteristics of support for various services though not commonly interacted with by the end customer.

A field 408 is an attribute tag to add additional detail to an object. A tag may be used to augment an object with a classifier and/or add additional detail to an object when a tag: value pair may be specified. Tags may be global to the organization as a whole, specific to a user, or a subset of users. Tags may be used to augment objects when mapped to an object and a value is set. Here you could have a uniform tag name (e.g. tag.name), which can be mapped to an object with a value set specific to the object (e.g. object1: tag.name: val1, object2: tag.name: val2). Attachments may be used to reference external artifacts to the system and may include URLs, uploads, knowledgebase articles, or any other applicable item relevant in the context of the item it is attached to. All objects in the system may link to others with the construct of a link object 410. This allows for pre-defined linkage between objects (e.g. defaults), or custom links 412 that customers wish to add to define relationships between objects. These linkages may also be used to flow information and/or events between objects. For example, an event may be generated from one object and sent to another over a link. An example, of this may be object state changes that may impact the state of a related object.

### SUMMARY OF THE INVENTION

One or more implementations of the present specification provides a framework to define the schema of a custom or customized object using multiple schemas. To achieve the objective above, one or more implementations of the present specification provide the following technical solutions:

An object is defined by multiple data fields that define an attribute and the value of such fields can be assigned by a user. The objects can be standard objects and custom objects. In the user interface of the existing ticketing frameworks, the user can extend the organization's data by defining customized and custom objects. Custom and customized objects allow storing information unique to such organization and used to accommodate customer demand for attaching customer specific information to fields in such custom objects. Further, administrators can define custom fields for standard or custom objects in their organization using the user interface. Client applications with sufficient permissions can invoke API calls on existing custom objects.

The current ticketing frameworks, such as Jira, allow users to add custom fields to each class of tickets. For example, one customer may want to attach a “root cause” field to ‘bugs’ (class of a ticket named ‘issue’), another may want to attach ‘references’ to internal documents to feature tickets. The existing naming conventions for the custom objects must have unique names and admin defines an associated name field for each custom object during setup. In the API, the names of custom objects include a suffix after customXXX where XXX is an integer or suffix can underscores followed by a lowercase “c”, for example root_cause_c. These suffixes are not desirable when coding against the API's.

Further, the existing ticketing frameworks fail to allow customizing the objects from multiple sources. Defining an object using multiple field attributes from different schemas is not supported in the current frameworks of defining a custom object. In the present frameworks naming conflicts can arise when multiple users want to add custom fields to the same class of an object. For example, when a project team adds a field called “references” and a third-party integration also wants to add a field with the same name but different type and semantics.

Personalization and customization is a core tenant of the platform allowing the user and/or partners to customize objects to suit their specific needs. There are multiple methods of “customization,” some being more formalized and controlled, some being targeted to organizations, and others leveraging temporary and/or ephemeral techniques. For the structured method a dynamic approach was leveraged where a given type's schema can be constructed based upon applicable fragments. Fragments (“schema fragments”) are a chunk of a schema that can be strung together to form a full schema. This allows users and organizations to customize and/or extend an object's schema without impacting all objects of that type. For example, an organization extending certain objects to include metadata specific and/or relevant to their application. For users this may include, organization specific attributes or types. Given that all objects inherit from base classes there exists consistency and requirements for certain system defined fields. The default options/fields for a base class (“schema”) would be stored as a schema fragment in the object DB (example scenario). Any extensions/customizations to these objects and/or object types would be done through the consolidation of schema fragments. The initial object's schema may be based upon a single fragment however, after customization and/or extension the object's schema may be constructed based upon one or more schema fragments.

In the embodiments of the present specification, the term “schema” is defined as a set of fields and their types available when creating an object. A Custom schema fragment (fragment) is a partial schema defining a set of custom fields and their types. Customized object is an object containing custom fields defined by one or more fragments. Custom object is an object containing only the custom fields defined by one or more fragments.

The first aspect of the one or more implementations of the present specification is to define schema fragments that comprise of multiple custom data fields wherein each fragment can be used to add custom data fields to multiple objects. Each schema fragment defines one or more custom fields by specifying the name, type and optionally validations for each field.

In accordance with the first aspect of the present specification, the single object can include custom data fields from multiple schema fragments. Each schema fragment is defined by a set of custom fields representing similar kind of data fields which are classified as ‘tenant custom fields’ defined and used for integrating with their internal systems by the tenants; ‘custom type fields’ used to extend existing class types with sub classes; and application custom fields which are defined for third party integrations that need to attach information to class types.

In accordance with the first aspect of the present specification, each schema fragment contains custom data fields of similar kind i.e., a fragment can comprise either tenant type custom fields or custom type data fields, or application type custom fields only. Each such fragment is labelled separately based on type of custom fields it contains like tenant schema fragments, custom type schema fragments and application schema fragments.

In accordance with the first aspect of the present specification, the object can contain a mixture of different types of custom fields and to achieve this a single object is defined by referencing multiple schema fragments.

In accordance with the first aspect of the present specification, the custom fields defined by different fragments are held in different namespaces in an object. Application fields, custom type fields and tenant custom fields defined with respective name spaces to prevent field name conflicts.

In accordance with the first aspect of the present specification, a user by using the API or a schema editor can create one or more schema fragments. An object is customized by attaching the desired fragments ids by reference (custom_schema_fragment_ids array). When a schema fragment is linked to an object all the custom fields defined in such fragment are available to be populated in the object.

The second aspect of the present specification is to provide immutable schema fragments. Any editing like insertion or deletion of any custom fields originally defined in schema fragment will result in creation of a new schema fragment that reflect the editions done on the original schema fragment.

In accordance with the second aspect of the present specification, immutable fragments facilitate forward and backward references to enable discovery of predecessor and successor fragments.

In accordance with the second aspect of the present specification, immutable fragments allow to retain the original defined fragments in the database and the custom object will be updated by the edited custom fields in the updated or newly created fragments. The immutable fragments further allow to update customized objects when fragments are updated and retain the originally defined schema that is used to describe the existing object. The main benefit of lazy updates is a reduction of system load.

The third aspect of the present specification is to facilitate custom objects updating when there is an update in the fragment that is referred by the object. Each custom object is defined by multiple custom fields from one or more fragments and when any one fragment is updated then the object gets updated.

In accordance with the third aspect of the present specification, the custom object gets updated by deleting the custom fields that do not exist in the respective fragment; including new fields with default values and also updating the fragment_id in the object.

In accordance with the third aspect of the present specification, to update the object: an object is read from a collection; verifying for the custom schema fragment_ids in the registry; checking for any update available for the custom fragment; if an updated fragment is available, the custom fields are updated; assigning default values to the updated fields and the fragment_id in the object is changed.

In accordance with the third aspect of the present specification, to update the object: an object is read from a collection; verifying for the custom schema fragment_ids in the registry; checking for any update available for the custom fragment; if an updated fragment is available, the custom fields are updated; assigning default values to the updated fields; the fragment_id in the object is changed; and the object in the database is overwritten.

In accordance with the third aspect of the present specification, to update the multiple objects that refer to a schema fragment: verifying for the custom schema fragment_ids in the registry; checking for any update available for the custom fragment; when an update notification is received, all the objects in the collection that reference to such updated fragment are updated by updating the custom fields referred in such updated fragment; assigning default values to the updated fields and substituting the fragment_id in all such objects.

In accordance with the third aspect of the present specification, the multiple objects that refer to an updated schema fragment can be updated on demand and this demand is triggered by a user. All the updated objects are overwritten in the database.

Other objects, aspects, features and goals of the present invention will be better understood from the following detailed description. The following description is illustrative in nature and is not intended to be in any way limiting. In addition to the illustrative aspects, embodiments, and features described above, further aspects, embodiments, and features will become apparent by reference to the following detailed description.

### BRIEF DESCRIPTION OF THE ACCOMPANYING DRAWINGS

The accompanying drawings illustrate the best mode for carrying out the invention as presently contemplated and set forth herein after. The present invention may be more clearly understood from a consideration of the following detailed description of the embodiments taken in conjunction with the accompanying drawings wherein like reference letters and numerals indicate the corresponding parts in various figures in the accompanying drawings, and in which:

FIG. 1 provides an illustration of the existing system to implement automated template for autonomous clustering and classification of events into event hierarchies.

FIG. 2 shows example identity relationships between the different clouds according to the existing system.

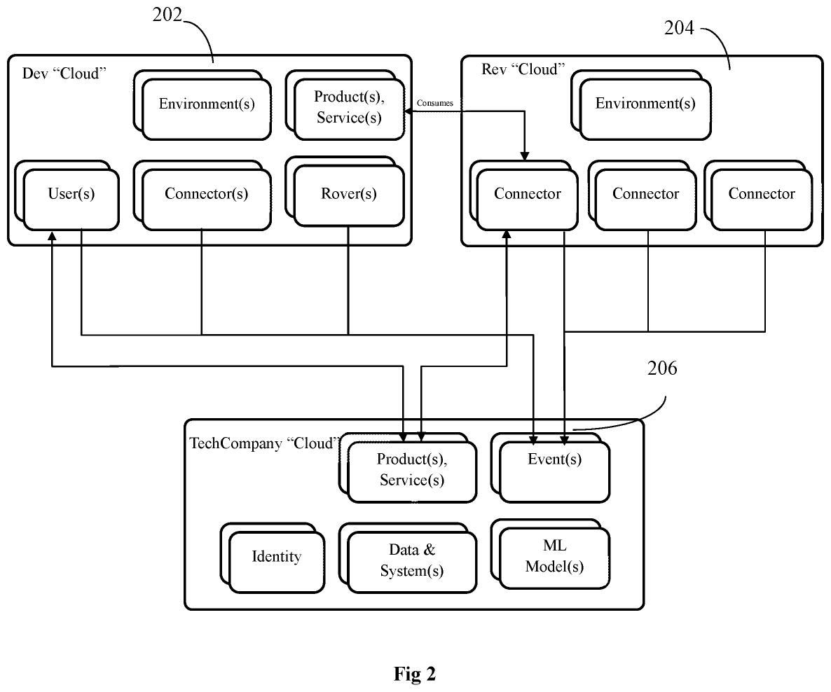

FIG. 3 illustrates the concept of TechCompany's direct customer (Devs) and their customers (Revs) and the fact that many devs may correspond to a single entity.

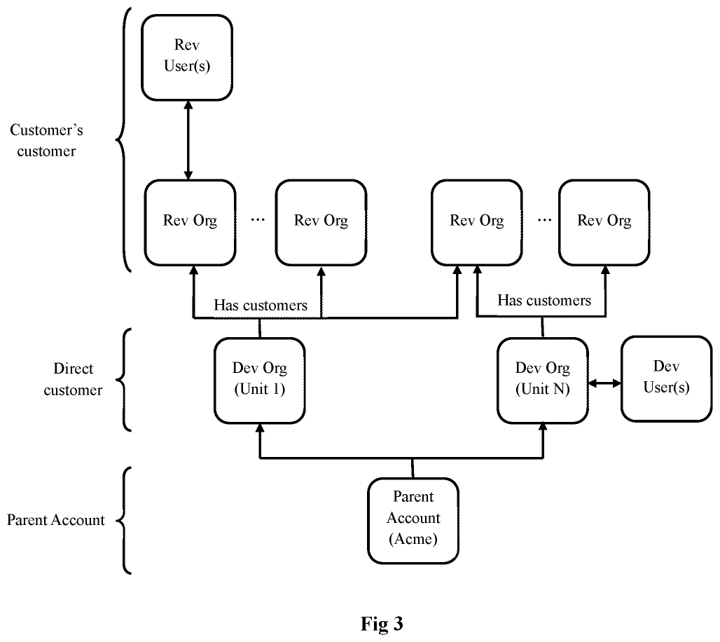

FIG. 4 illustrates the notion of identity and how a person's identity can be composed of multiple user ids or traits.

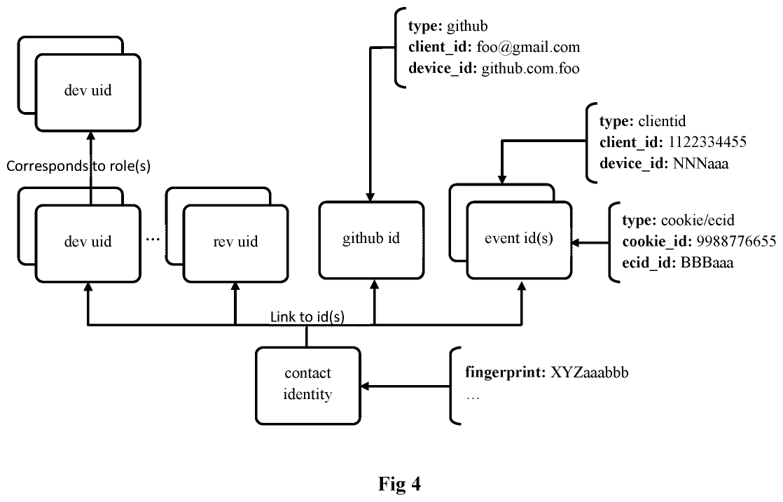

FIG. 5 shows an illustration of logical relationships that may exist between dev/rev orgs/users.

FIG. 6 illustrates base classes correspond to the main classes that objects will be based upon.

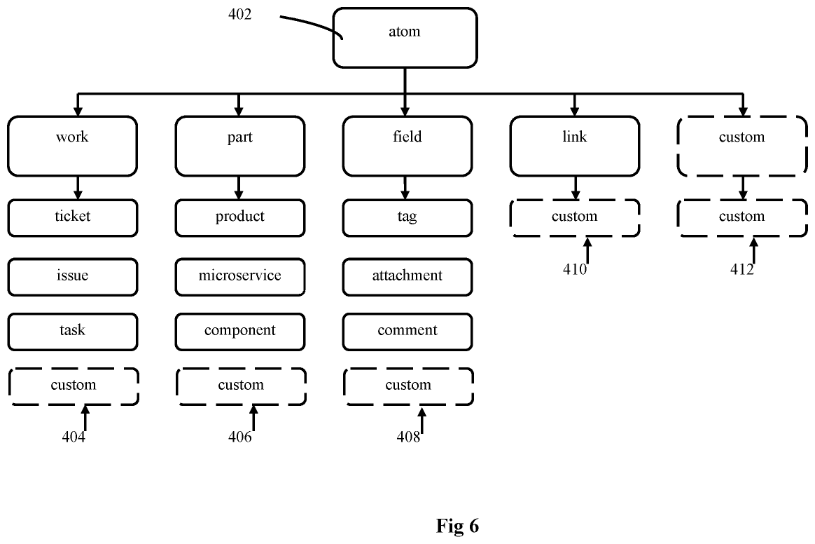

FIG. 7 illustrates components of a fragment in accordance with the present invention.

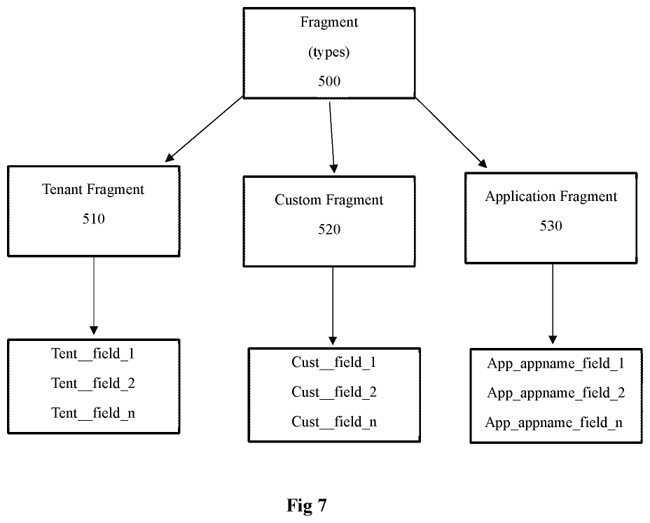

FIG. 8 illustrates a process flow of creating a fragment in accordance with the present invention.

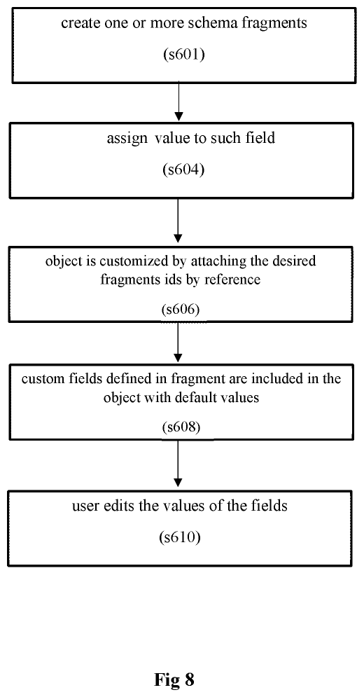

FIG. 9 illustrates relation of a fragment with multiple objects in accordance with the present invention.

FIG. 10 illustrates relation of multiple types of fragment with ‘n’ number of objects in accordance with the present invention.

FIG. 11 illustrates updating of fragment and objects linked to such fragment in accordance with the present invention.

FIG. 12 illustrates updating of multiple fragments and multiple objects related to such fragments in accordance with the present invention.

FIG. 13 illustrates a process flow of updating a fragment and object linked to such fragment.

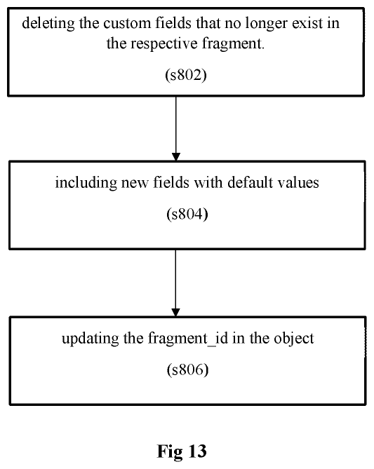

FIG. 14 illustrates a process flow of updating multiple fragments and multiple objects.

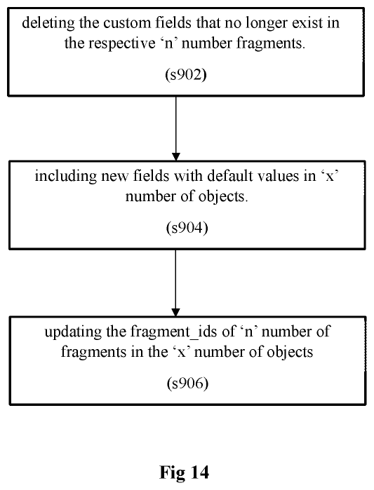

FIG. 15 illustrates a process flow of updating an object with read function in accordance with one of the embodiments of the present invention.

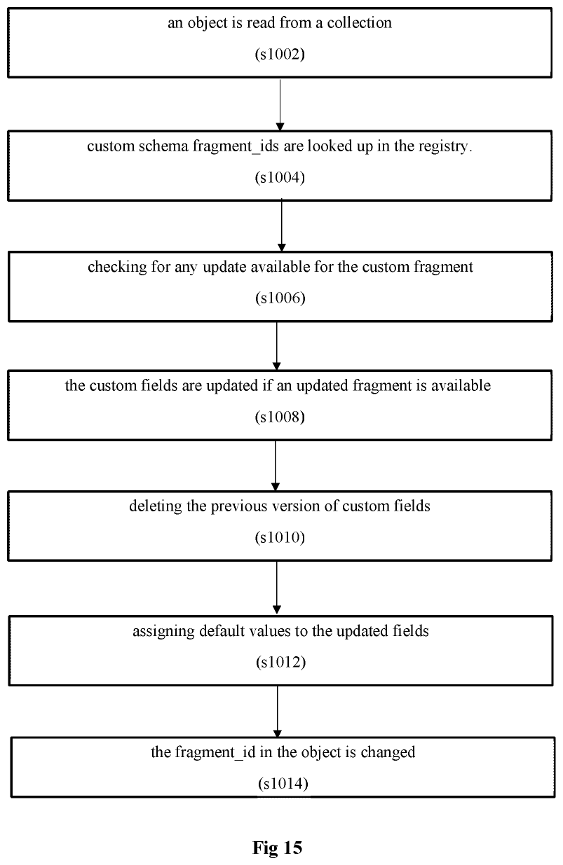

FIG. 16 illustrates a process flow of updating an object with write back function in accordance with one of the embodiments of the present invention.

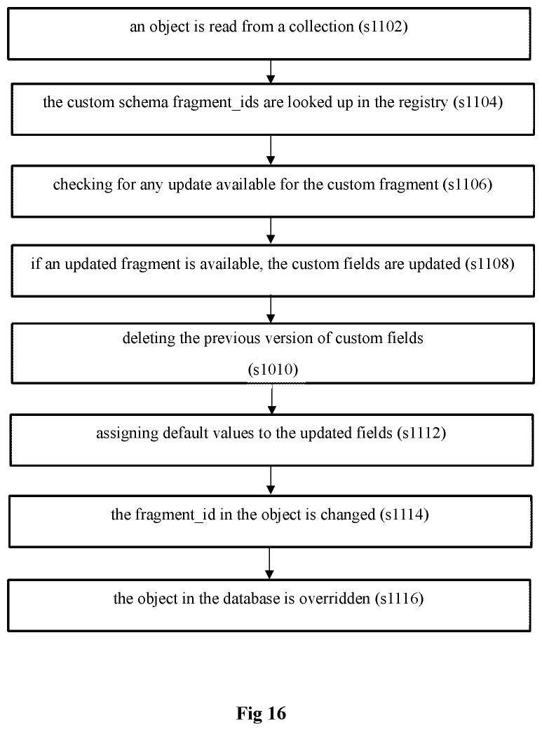

FIG. 17 illustrates a process flow of asynchronous updating of ‘n’ number objects with write back function in accordance with one of the embodiments of the present invention

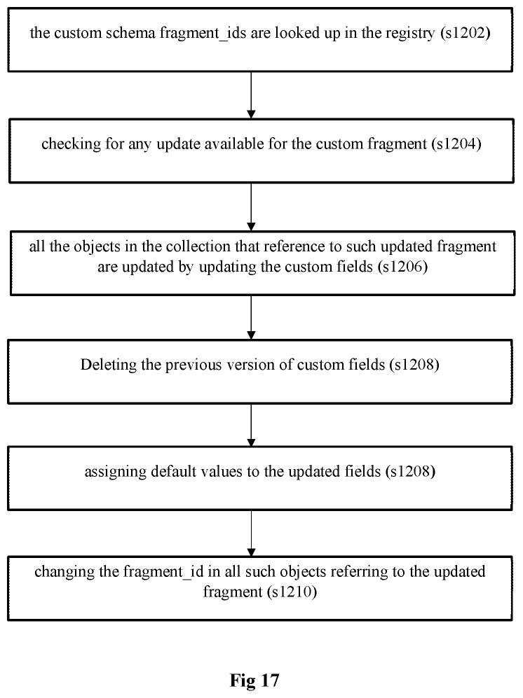

FIG. 18 illustrates a process flow of asynchronous updating of ‘n’ number objects upon demand in accordance with one of the embodiments of the present invention.

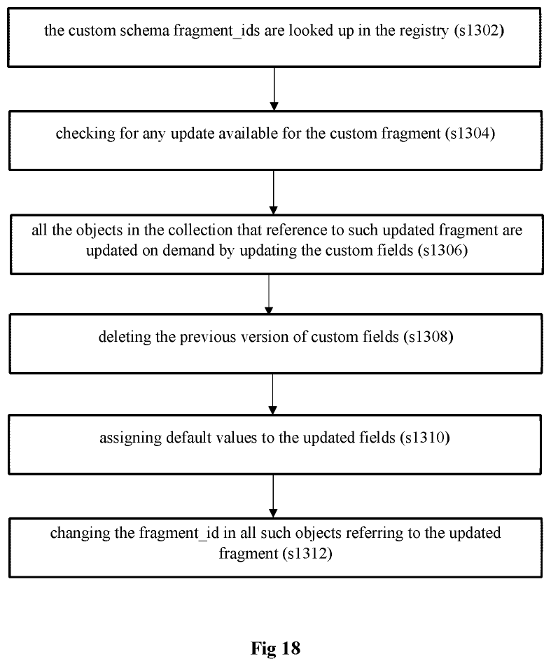

FIG. 19 block diagram of an illustrative computing system suitable for implementing an embodiment of the present invention.

### DETAILED DESCRIPTION OF ILLUSTRATED EMBODIMENTS OF THE PRESENT INVENTION

Example implementations are described in detail here, and examples of the example implementations are presented in the accompanying drawings. When the following description relates to the accompanying drawings, unless specified otherwise, same numbers in different accompanying drawings represent same or similar elements. The implementations described in the following example implementations do not represent all implementations that are consistent with one or more implementations of the present specification. On the contrary, the implementations are only examples of apparatuses and methods that are described in the appended claims in detail and consistent with some aspects of one or more implementations of the present specification.

It is worthwhile to further note that the term “include”, “contain”, or their any other variant is intended to cover a non-exclusive inclusion, so that a process, a method, merchandise, or a device that includes a list of elements not only includes those elements but also includes other elements which are not expressly listed, or further includes elements inherent to such process, method, merchandise, or device. An element preceded by “includes a . . . ” does not, without more constraints, preclude the existence of additional identical elements in the process, method, merchandise, or device that includes the element.

The terms used in the one or more implementations of the present specification are merely used for the purpose of describing specific implementations and are not intended to limit the one or more of the implementations of the present specification. The terms “a”, “said”, and “the” of singular forms used in the present specification and the appended claims are also intended to include plural forms, unless otherwise specified in the context clearly. It should also be understood that the term “and/or” used in the present specification indicates and includes any or all possible combinations of one or more associated listed items.

The present specification discloses a method to define schema fragments (also known as fragment(s)) that comprise multiple custom data fields wherein each fragment can be used to add custom data fields to multiple objects. In the embodiment, a single object can include custom data fields from multiple schema fragments. Each schema fragment is defined by a set of custom fields representing similar kind of data fields (like tenant data field, custom data filed, application data fields).

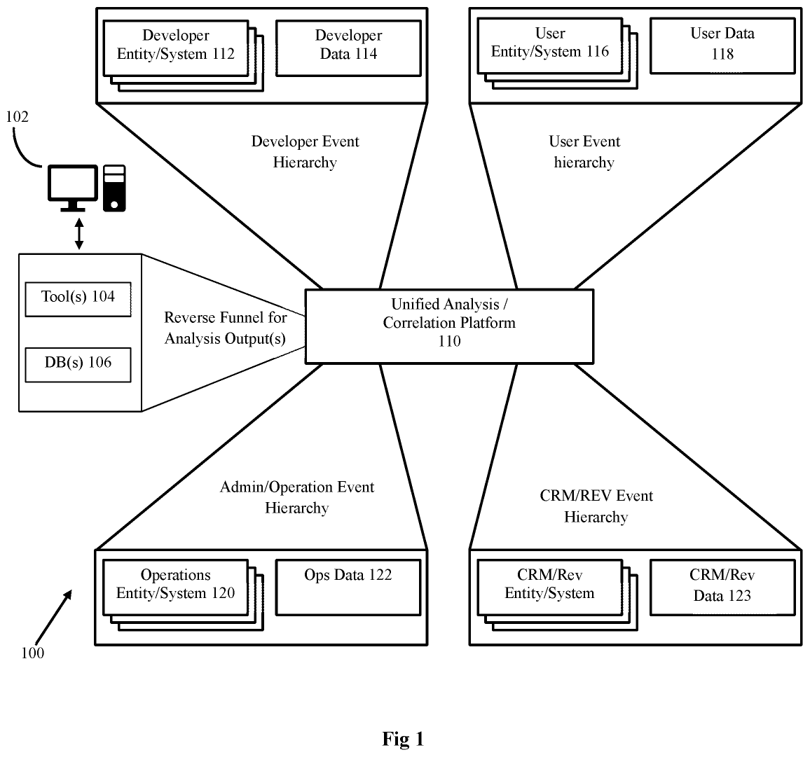

In accordance with the embodiment, there can be ‘tenant custom fields’ defined and used for integrating with their internal systems by the tenants; ‘custom fields’ used to extend existing class types with sub classes; and application custom fields which are defined for third party integrations that need to attach information to class types as depicted in FIG. 1. Each schema fragment 500 contains custom data fields of similar kind i.e., a fragment can comprise any one type among of the tenant type custom fields, custom type data fields, application type custom fields. Each such fragment is labelled separately based on type of custom fields it contains like tenant schema fragments 510, custom type schema fragments 520 and application schema fragments 530. Each fragment can define multiple objects from multiple schemas.

In accordance with the embodiment, the custom fields defined by different fragments are held in different namespaces in an object. Application fields, custom type fields and tenant custom fields defined with respective name spaces to prevent field name conflicts. In conventional systems like Jira, any custom fields are named as customXXXX in the API, where XXXX is an integer. This definition or naming of a custom field is not desirable when coding against the API.

### For Example

{
“ticket_id”: “ISS-123”,
“custom3401”: “root cause was hardware breakage”,
...
}

In another framework salesforce the custom fields are suffixed with “_c” to distinguish them from stock or standard fields (common to all objects defined under an organization). This is an improvement over Jira, but only a single namespace for custom fields is allowed. For example:

{
“ticket_id”: “ISS-123”,
“root_cause_{——}c”: “root cause was hardware breakage”,
...
}

Further Jira and salesforce does not provide a way to customize an object from multiple sources. Here the sources can be schemas where an object is defined by a single schema.

The limitations for defining or naming the custom fields as cited in the existing system can be solved by defining custom fields under a separate data entity like schema fragments which comprises multiple custom fields and the type or source of creation of such custom fields is same. Each fragment can contain custom fields generated by a tenant organization or through users or through applications. The type of fragment 500 and each type of fragment contains custom fields originated from similar source.

In one of the embodiments, a user by using the API or a schema editor can create one or more schema fragments s602. Each fragment should be updated with custom fields wherein each fragment should comprise at least one custom field and there can be a default value assigned to such field s604. An object is customized by attaching the desired fragments ids by reference (custom_schema_fragment_ids array) s606. When a fragment is linked to the object, all the custom fields defined in such fragment are included in the object with default values s608. The user can edit the values of the custom fields s610.

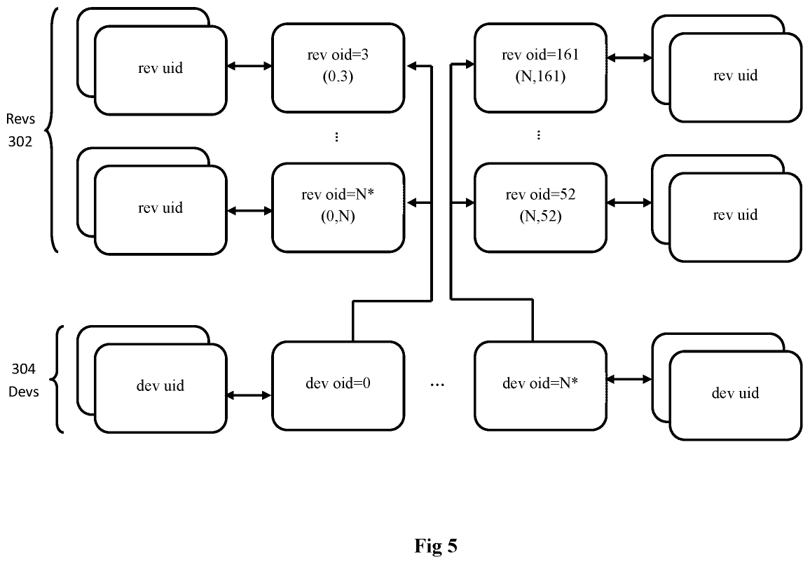

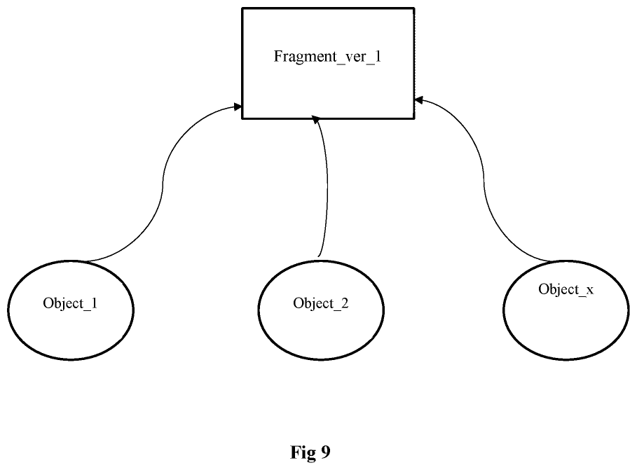

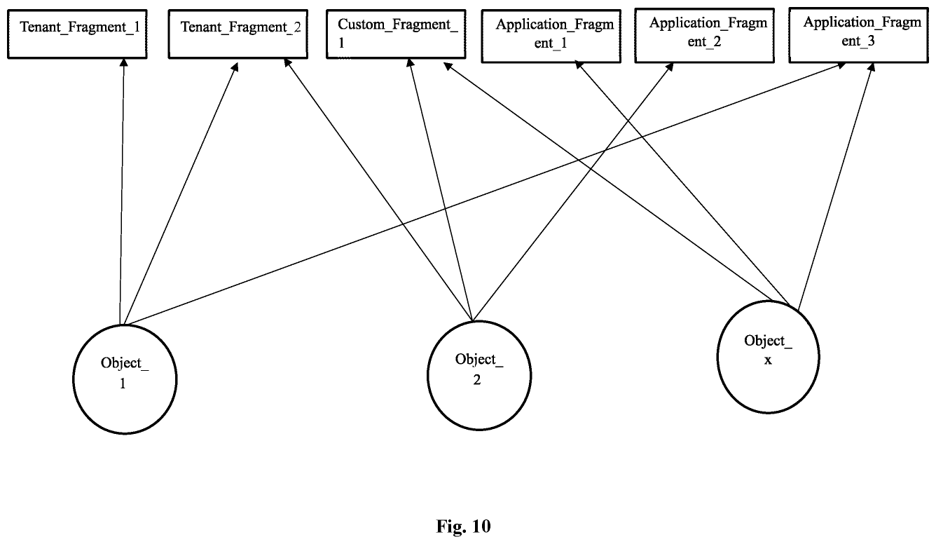

In an embodiment, each fragment can be linked to many data objects from multiple schemas. FIG. 9 depicts the linking of a schema fragment to multiple objects defined under same or multiple schemas. Similarly, multiple fragments of different types as defined in FIG. 5 can be linked to many data objects from multiple schemas. FIG. 10 depicts the linking of a multiple schema fragments to multiple objects defined under the same or multiple schemas.

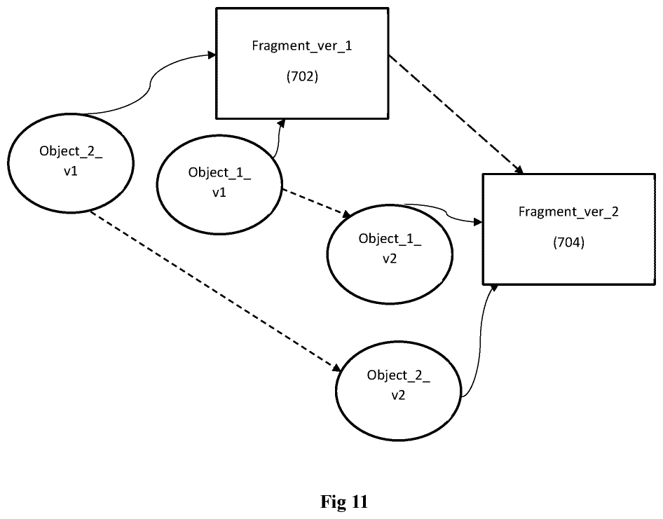

In another embodiment as shown in FIG. 11 the schema fragments are immutable. Any editing like insertion or deletion of any custom fields originally defined in a schema fragment 702 will result in creation of a new immutable schema fragment 704 that reflects the edits done on the original schema fragment 702. The immutable fragments 704 facilitate forward and backward references to enable discovery of predecessor and successor fragments. This is also known as lazy update. Further the immutable fragments allow to retain the original defined fragments in the database and the custom object(s) will be updated by the edited custom fields in the newly created fragments. The immutable fragments further allow to update customized objects when fragments are updated and retain the originally defined schema that is used to describe the existing object. The main benefit of lazy updates is a reduction of system load.

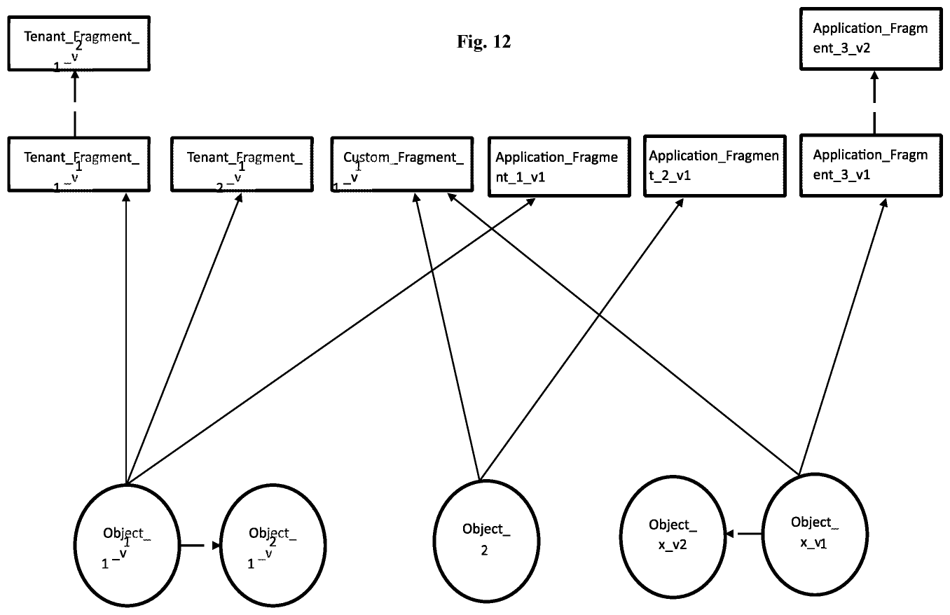

In another embodiment as shown in FIG. 12 any editing like insertion or deletion of any custom fields originally defined in multiple schema fragments will result in creation of a new version of such schema fragments that reflect the edits done on the original schema fragments. The custom objects are updated when there is an update in the fragment that is referred by the object. Each custom object is defined by one or more custom fields from one or more fragments and when any one fragment is updated then the object gets updated. The custom fields defined by different fragments are held in different namespaces in an object. Application or stock fields, custom type fields and tenant custom fields live in their respective name spaces to prevent field name conflicts. The namespaces are implemented by way of prefixing field names in the custom field map in instantiated objects.

In an exemplary embodiment, the Template custom field names are in the form “tmpl_”; the tenant custom field names are in the form “cust_” and the App custom field names are in the form “app_”.

For illustration, a fully populated object can be: {
“id”=,
... // other static stock fields
// references to schema fragments used
“schema_fragments”: [,],
// map of custom fields
“custom_fields”: {
“tmpl_{——}field_1”: 1234,
“tmpl_{——}field_2”: “def’,
“cust_{——}field_1”: “enterprise custom data”,
“cust_{——}field_2”: 663,
“app_sfdc_{——}field_1”: 567,
“app_sfdc_{——}field_5”: “ghi”,
“app_plx_{——}field_1”: 888,
“app_plx_{——}field_5”: “jkl”
}

In another embodiment, the fragment gets updated by deleting the custom fields that do not exist in the respective fragment s802; including new fields with default values s804 and also updating the fragment_id in the object s806.

In another embodiment, multiple fragments get updated by deleting the custom fields that do not exist in the respective ‘n’ number fragments s902; including new fields with default values in ‘x’ number of objects s904 and also updating the fragment_ids of ‘n’ number of fragments in the ‘x’ number of objects s906.

In another embodiment to update the object: an object is read from a collection s1002; verifying for the custom schema fragment_ids in the registry s1004; checking for any update available for the custom fragment s1006; if an updated fragment is available, the custom fields are updated s1008; deleting previous version of custom fields s1010; assigning default values to the updated fields s1012; and the fragment_id in the object is changed s1014.

In another embodiment to update the object: an object is read from a collection s1102; verifying for the custom schema fragment_ids in the registry s1104; checking for any update available for the custom fragment s1106; if an updated fragment is available, the custom fields are updated s1108; deleting previous version of custom fields s110; assigning default values to the updated fields s1112; the fragment_id in the object is changed s1114; and the object in the database is overridden s1116.

In another embodiment, to update the multiple objects that refer to a schema fragment; verifying for the custom schema fragment_ids in the registry s1202; checking for any update available for the custom fragment s1204; when an update notification is received, all the objects in the collection that refer to such updated fragment are updated by updating the custom fields s1206; deleting previous version of custom fields s1208; assigning default values to the updated fields s1210; and substituting the fragment_id in all such objects referring to the updated fragment s1212.

In another embodiment updating multiple objects is achieved by verifying for the custom schema fragment_ids in the registry; checking for any update available for the custom fragment; updating multiple objects in the collection that refer to such updated fragment and updating the custom fields in reference to such updated fragment; deleting previous version of custom fields; assigning default values to the updated fields; substituting the fragment_id in all such objects referring to the updated fragment; and overwriting the multiple objects in the database.

In another embodiment, the multiple objects that refer to an updated schema fragment can be updated on demand and this demand is triggered by a user. All the updated objects are overwritten in the database. The custom schema fragment_id is looked up in the registry s1302; checking for any update available for the custom fragment s1304; when an update notification is received, all the objects in the collection that refer to such updated fragment are updated on demand by updating the custom fields s1306; deleting previous version of custom fields s1308; assigning default values to the updated fields s1310 in all the objects and substituting the fragment_id in all such objects s1312.

In another embodiment updating object is achieved by verifying for the custom schema fragment_ids in the registry; checking for any update available for the custom fragment; updating object on demand in the collection that refer to such updated fragment and also updating the custom fields in reference to such updated fragment; deleting previous version of custom fields; assigning default values to the updated fields; substituting the fragment_id in all such objects referring to the updated fragment; and overwriting the object in the database.

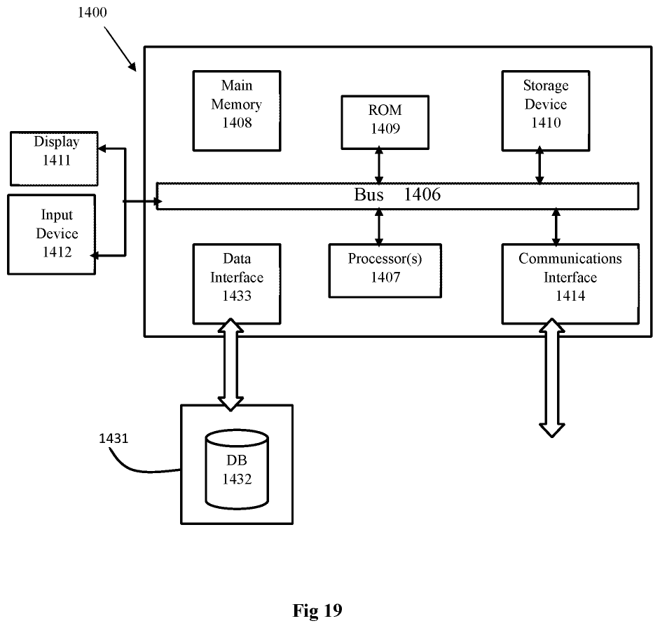

FIG. 19 is a block diagram of an illustrative computing system 1400 suitable for implementing an embodiment of the present invention. Computer system 1400 includes a bus 1406 or other communication mechanism for communicating information, which interconnects subsystems and devices, such as processor 1407, system memory 1408 (e.g., RAM), static storage device 1409 (e.g., ROM), disk drive 1410 (e.g., magnetic or optical), communication interface 1414 (e.g., modem or Ethernet card), display 1411 (e.g., CRT or LCD), input device 1412 (e.g., keyboard), and cursor control.

According to one embodiment of the invention, computer system 1400 performs specific operations by processor 1407 executing one or more sequences of one or more instructions contained in system memory 1408. Such instructions may be read into system memory 1408 from another computer readable/usable medium, such as static storage device 1409 or disk drive 1410. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

The term “computer readable medium” or “computer usable medium” as used herein refers to any medium that participates in providing instructions to processor 1407 for execution. Such a medium may take many forms, including but not limited to, non-volatile media and volatile media. Non-volatile media includes, for example, optical or magnetic disks, such as disk drive 1410. Volatile media includes dynamic memory, such as system memory 1408. A database 1432 may be accessed in a computer readable medium 1431 using a data interface 1433.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 1400. According to other embodiments of the invention, two or more computer systems 1400 coupled by communication link 1415 (e.g., LAN, PTSN, or wireless network) may perform the sequence of instructions required to practice the invention in coordination with one another.

Computer system 1400 may transmit and receive messages, data, and instructions, including program, i.e., application code, through communication link 1415 and communication interface 1414. Received program code may be executed by processor 1407 as it is received, and/or stored in disk drive 1410, or other non-volatile storage for later execution.

In a typical configuration, the computer includes one or more processors (CPU), an input/output interface, a network interface, and a memory. The memory can include a non-persistent memory, a random-access memory (RAM) and/or a nonvolatile memory in a computer readable medium, for example, a read-only memory (ROM) or a flash memory (flash RAM). The memory is an example of the computer readable medium.

Features described as separate implementations may be implemented, in combination, in a single implementation, while features described as a single implementation may be implemented in multiple implementations, separately, or in any suitable sub-combination. Operations or processes or methods described and claimed in a particular order should not be understood as requiring that the particular order, nor that all illustrated operations must be performed (some operations can be optional). As appropriate, multitasking or parallel-processing (or a combination of multitasking and parallel-processing) can be performed.

Specific implementations of the present specification are described above. Other implementations fall within the scope of the appended claims. In some situations, the actions or steps described in the claims can be performed in an order different from the order in the implementations and the desired results can still be achieved. In addition, the process described in the accompanying drawings does not necessarily need a particular execution order to achieve the desired results. In some implementations, multitasking and parallel processing can be advantageous.

The descriptions above are only example implementations of the one or more implementations of the present specification but are not intended to limit one or more implementations of the present specification. Any modification, equivalent replacement, improvement, etc. made without departing from the scope and principle of the one or more implementations of the present specification shall fall within the protection scope of the one or more implementations of the present specification.

What is claimed is:

1. A computer implemented method, comprising:
creating one or more schema fragments using an API or a schema editor;
updating one or more schema fragments;
assigning default values to a custom field wherein each schema fragment should comprise at least one custom field;
updating one or more objects by attaching a schema fragment id by reference;
including all the custom fields of the schema fragment by default in the object; and
editing the values of the custom fields in the object.

2. The computer implemented method of claim 1, wherein updating the schema fragment further comprising: deleting the custom fields that do not exist in the respective schema fragment; including new custom fields with default values; and updating the schema fragment id in the object.

3. The computer implemented method of claim 1, wherein updating one or more schema fragments further comprising: deleting the custom fields that do not exist in respective ‘n’ number fragments; including new fields with default values in ‘x’ number of objects; and updating fragment ids of ‘n’ number of fragments in the ‘x’ number of objects.

4. The computer implemented method of claim 1, wherein updating the object further comprising: reading the object from a collection; verifying for a custom fragment id in a registry; checking for any update available for the custom fragment id; updating custom fields if an updated fragment is available; deleting previous version of the custom fields; assigning default values to the updated custom fields; substituting the fragment id in the object.

5. The computer implemented method of claim 1, wherein updating the object further comprising: reading the object from a collection; verifying for a custom fragment id in a registry; checking for any update available for the custom fragment id; updating custom fields if an updated fragment is available; deleting previous version of the custom fields; assigning default values to the updated custom fields; substituting the schema fragment id in the object; and overwriting the object in a database.

6. The computer implemented method of claim 1, wherein updating one or more objects further comprising: verifying for a custom fragment id in a registry; checking for any update available for the custom fragment id; updating multiple objects in a collection that refer to such updated fragment and updating the custom fields in reference to such updated fragment; deleting previous version of custom fields; assigning default values to the updated fields; and substituting the schema fragment id in all such objects referring to the updated fragment.

7. The computer implemented method of claim 1, wherein updating one or more objects further comprising: verifying for a custom fragment id in a registry; checking for any update available for the custom fragment id; updating multiple objects in a collection that refer to such updated fragment and updating the custom fields in reference to such updated fragment; deleting previous version of custom fields; assigning default values to the updated fields; substituting the schema fragment id in all such objects referring to the updated fragment; and overwriting the multiple objects in a database.

8. The computer implemented method of claim 1, wherein updating the object further comprising: verifying for a custom fragment id in a registry; checking for any update available for the custom fragment id; updating object on demand in a collection that refer to such updated fragment and also updating the custom fields in reference to such updated fragment; deleting previous version of custom fields; assigning default values to the updated fields; and substituting the schema fragment id in all such objects referring to the updated fragment.

9. The computer implemented method of claim 1, wherein updating the object further comprising: verifying for a custom schema fragment id in a registry; checking for any update available for the custom fragment id; updating object on demand in a collection that refer to such updated fragment and also updating the custom fields in reference to such updated fragment; deleting previous version of custom fields; assigning default values to the updated fields; substituting the schema fragment id in all such objects referring to the updated fragment; and overwriting the object in a database.

10. The computer implemented method of claim 1, wherein the schema fragments are immutable.

11. A computer processing system comprises a processing unit; a communications interface; and a non-transitory computer-readable storage medium to store instructions, wherein the processing unit execute the stored instructions: to create of one or more schema fragments using an API or a schema editor; to update one or more schema fragments; to assign default values to a custom field wherein each schema fragment should comprise at least one custom field; to update one or more objects by attaching a schema fragment id by reference; to include all the custom fields of the schema fragment by default in the object; and to allow editing the values of the custom fields in the object.

12. The computer processing system of claim 11, wherein the processing unit updates the schema fragment that further comprises deletion of the custom fields that do not exist in the respective schema fragment; assignment of default values to any new custom fields and updating of the schema fragment id in the object.

13. The computer processing system of claim 11, wherein the processing unit updates one or more schema fragments that further comprises deletion of the custom fields that do not exist in respective ‘n’ number fragments; inclusion of new fields with default values in ‘x’ number of objects; and updating of fragment ids of ‘n’ number of fragments in the ‘x’ number of objects.

14. The computer processing system of claim 11, wherein the processing unit updates the object that further comprises to read the object from a collection; verification of a custom fragment id in a registry; to check for any update available for the custom fragment id; updating of the custom fields if an updated fragment is available; deletion of previous version of custom fields; assignment of default values to the updated custom fields; and substitution of the schema fragment id in the object.

15. The computer processing system of claim 11, wherein the processing unit updates the object that further comprises to read the object from a collection; verification of a custom fragment id in a registry; to check for any update available for the custom fragment id; updating of the custom fields if an updated fragment is available; deletion of any previous version of custom fields; assignment of default values to the updated custom fields; substitution of the schema fragment id in the object; and to override the object in a database.

16. The computer processing system of claim 11, wherein the processing unit updates one or more objects that further comprises verification of a custom fragment id in a registry; to check for any update available for the custom fragment id; updating of multiple objects in a collection that refer to such updated fragment and updating of the custom fields in reference to such updated fragment; deletion of any previous version of custom fields; assignment of default values to the updated fields; and substitution of the schema fragment id in all such objects referring to the updated fragment.

17. The computer processing system of claim 11, wherein the processing unit updates one or more objects that further comprises verification of a custom fragment id in a registry; to check for any update available for the custom fragment id; updating of multiple objects in a collection that refer to such updated fragment and updating of the custom fields in reference to such updated fragment; deletion of previous version of custom fields; assignment of default values to the updated fields; substitution of the schema fragment id in all such objects referring to the updated fragment; and to override the multiple objects in a database.

18. The computer processing system of claim 11, wherein the processing unit updates the object that further comprises verification of a custom fragment id in a registry; to check for any update available for the custom fragment id; updating of object on demand in a collection that refer to such updated fragment and also updating of the custom fields in reference to such updated fragment; deletion of previous version of custom fields; assignment of default values to the updated fields; and substitution of the schema fragment id in all such objects referring to the updated fragment.

19. The computer processing system of claim 11, wherein the processing unit updates the object that further comprises verification of a custom fragment id in a registry; to check for any update available for the custom fragment id; updating of object on demand in a collection that refer to such updated fragment and also updating of the custom fields in reference to such updated fragment; deletion of previous version of custom fields; assignment of default values to the updated fields; substitution of the schema fragment id in all such objects referring to the updated fragment; and to override the object in a database.

20. The computer processing system of claim 11, wherein the schema fragments are immutable.

21. A computer-readable medium comprising computer executable instructions that when executed by a processor of a computer, allows the processor to perform a method comprising: creating one or more schema fragments using an API or a schema editor; updating one or more schema fragments; assigning default values to a custom field wherein each schema fragment should comprise at least one custom field; updating one or more objects by attaching a schema fragment id by reference; including all the custom fields of the schema fragment by default in the object; and editing the values of the custom fields in the object.

22. The computer-readable medium of claim 21, wherein updating the schema fragment further comprising: deleting the custom fields that do not exist in the respective schema fragment; including new custom fields with default values; and updating the schema fragment id in the object.

23. The computer-readable medium of claim 21, wherein updating one or more schema fragments further comprising: deleting the custom fields that do not exist in respective ‘n’ number fragments; including new fields with default values in ‘x’ number of objects; and updating fragment ids of ‘n’ number of fragments in the ‘x’ number of objects.

24. The computer-readable medium of claim 21, wherein updating the object further comprising: reading the object from a collection; verifying for a custom fragment id in a registry; checking for any update available for the custom fragment id; updating custom fields if an updated fragment is available; deleting previous version of the custom fields; assigning default values to the updated custom fields; substituting the schema fragment id in the object.

25. The computer-readable medium of claim 21, wherein updating the object further comprising: reading the object from a collection; verifying for a custom fragment id in a registry; checking for any update available for the custom fragment id; updating custom fields if an updated fragment is available; deleting previous version of the custom fields; assigning default values to the updated custom fields; substituting the schema fragment id in the object; and overwriting the object in a database.

26. The computer-readable medium of claim 21, wherein updating one or more objects further comprising: verifying for a custom fragment id in a registry; checking for any update available for the custom fragment id; updating multiple objects in a collection that refer to such updated fragment and updating the custom fields in reference to such updated fragment; deleting previous version of custom fields; assigning default values to the updated fields; and substituting the schema fragment id in all such objects referring to the updated fragment.

27. The computer-readable medium of claim 21, wherein updating one or more objects further comprising: verifying for a custom fragment id in a registry; checking for any update available for the custom fragment id; updating multiple objects in a collection that refer to such updated fragment and updating the custom fields in reference to such updated fragment; deleting previous version of custom fields; assigning default values to the updated fields; substituting the schema fragment id in all such objects referring to the updated fragment; and overwriting the multiple objects in a database.

28. The computer-readable medium of claim 21, wherein updating the object further comprising: verifying for a custom fragment id in a registry; checking for any update available for the custom fragment id; updating object on demand in a collection that refer to such updated fragment and also updating the custom fields in reference to such updated fragment; deleting previous version of custom fields; assigning default values to the updated fields; and substituting the schema fragment id in all such objects referring to the updated fragment.

29. The computer-readable medium of claim 21, wherein updating the object further comprising: verifying for a custom fragment id in a registry; checking for any update available for the custom fragment id; updating object on demand in a collection that refer to such updated fragment and also updating the custom fields in reference to such updated fragment; deleting previous version of custom fields; assigning default values to the updated fields; substituting the schema fragment id in all such objects referring to the updated fragment; and overwriting the object in a database.

30. The computer-readable medium of claim 21, wherein the schema fragments are immutable.

31. A computer implemented method to define schema fragments that comprises multiple custom data fields wherein each schema fragment can be used to add custom data fields to multiple objects, wherein each schema fragment is defined by a set of custom fields representing similar kind of data fields, wherein each schema fragment can define multiple objects from multiple schemas.

32. The computer implemented method of claim 31, wherein the schema fragments are immutable.
